(19) United States
(12) Patent Application Publication
(10) Pub. No.: US 2013/0096932 A1
(43) Pub. Date: Apr. 18, 2013

(54) SYSTEMS AND METHODS FOR PROVIDING HEALTH CARE CREDITS TO SUBSCRIBERS

(71) Applicants: Andrew M. Saidel, North Potomac, MD (US); Davd K. Rosen, Guilford, CT (US)

(72) Inventors: Andrew M. Saidel, North Potomac, MD (US); Davd K. Rosen, Guilford, CT (US)

(73) Assignee: Stage 5 Innovation, LLC.

(21) Appl. No.: 13/273,366

(22) Filed: Oct. 14, 2011

(51) Int. Cl. G06Q 50/22

(52) U.S. Cl. 705/2

(57) ABSTRACT

Systems and methods to manage health insurance are described. An individual can submit a request to enroll in a health insurance plan of an insurance provider. The individual can complete a health assessment with a health care provider associated with the insurance provider, and the insurance provider can review results of the health assessment to determine an amount of health care credits to award to the individual. An account servicer can manage a health care credits account associated with the individual. In implementations, the individual can be rewarded with additional health care credits on a periodic or event-driven basis, based on a health of the individual and other factors.

### FIELD

This invention generally relates to systems and methods for health care operations. More particularly, this invention relates to platforms and techniques for monetizing health care services for subscribers.

### BACKGROUND

Current health care systems throughout the world operate on either an insurance or cash basis. In particular, users or subscribers of health care services either subscribe to public and/or private health insurance plans, or pay cash for health care services. Further, some systems offer mixed payment services in which subscribers can pay for health care services in part through health insurance and in part with cash. In some countries, numerous individuals neither participate in health insurance plans nor pay cash. Often as a result, these individuals engage in little or no preventative care or health management. They wait until medical conditions become acute before seeking treatment, which can necessitate seeking treatment at emergency rooms or similar facilities. While care is given to these individuals, the care can be expensive and the costs of the care are often not borne by the care recipients themselves. Instead, the costs are typically passed down to individuals who do, in fact, participate in a health insurance plan or pay cash.

For subscribers of health insurance plans, there are very limited health care system incentives to take responsibility for their own health and well-being. In particular, insurance, by its very nature, is designed to cover costs when an adverse event, or, applied to health care insurance, when a subscriber requires a service. Thus, insurance provides limited or no benefit to subscribers who maintain and improve their health and well-being. Further, the vast majority of consumers of health insurance use far fewer health care services than they pay for over the course of their enrollment. Therefore, current health insurance systems, like other insurance systems, are aggregated systems that pay for health care services and make a profit based on having more “light users” than “heavy users.”

It may, therefore, be desirable to provide systems and methods for rewarding good health, improved health, and well-being. It may also be desirable to provide platforms and techniques for providing transferrable health care credits as a reward for good health, improved health, well-being, and other factors.

### SUMMARY

Implementations are directed to systems and methods for managing health care. According to exemplary implementations in one regard, a method of encouraging healthy behavior by an individual is disclosed. According to the method, a health level of the individual can be determined, and an amount of health care credits to award to the individual based on the health level can be calculated. Further, the amount of health care credits can be provided to the individual.

According to implementations in another regard, a system for encouraging healthy behavior by an individual is disclosed. The system comprises a computer readable storage medium containing instructions and a processor operably connected to the computer readable storage medium. The processor can execute the instructions to perform operations comprising determining a health level of the individual and calculating an amount of health care credits to award to the individual based on the health level. Further, executing the instructions can perform operations further comprising providing, to the individual, the amount of health care credits.

According to implementations in another regard, a method of encouraging healthy behavior is disclosed. According to the method, a result of a health assessment of an individual can be examined to determine a health level of the individual, and an amount of health care credits to award to the individual can be calculated based on the health level of the individual. Further, the amount of health care credits can be provided into an account of the individual.

### BRIEF DESCRIPTION OF THE DRAWINGS

The accompanying drawings, which are incorporated in and constitute a part of this specification, illustrate implementations of the present disclosure and together with the description, serve to explain the implementations.

FIG. 1 illustrates a functional block diagram of an exemplary health insurance system according to various implementations.

FIG. 2 illustrates a detailed functional block diagram of an exemplary data processing component according to various implementations.

FIG. 3 is an exemplary output statement according to various implementations.

FIG. 4 is a flow diagram illustrating exemplary processing of health insurance data according to various implementations.

FIG. 5 is a flow diagram illustrating exemplary processing of health insurance data according to various implementations.

FIG. 6 is a flow diagram illustrating exemplary processing of health insurance data according to various implementations.

FIG. 7 is a flow diagram illustrating exemplary processing of health insurance data according to various implementations.

FIG. 8 illustrates an exemplary hardware configuration of a component that may be used in processing data according to various implementations.

### RELATED APPLICATIONS

This application is related to commonly-assigned, co-pending applications: Ser. No. ______ and entitled “SYSTEMS AND METHODS FOR PROCESSING THE REDEMPTION OF HEALTH CARE CREDITS”; and Ser. No. ______ and entitled “SYSTEMS AND METHODS FOR EXCHANGING HEALTH CARE CREDITS”; filed the same day as the present application, the entire disclosures of which are incorporated herein by reference.

### DETAILED DESCRIPTION

Implementations are directed towards systems and methods for providing payments of health care charges in the form of a health care credits system (HCCS). In various embodiments, an insurance provider can offer HCCS insurance plans as an alternative or in addition to a conventional health insurance plan. Various embodiments of a HCCS reward an individual's good health, improved health, and well-being maintenance with health care credits, which may be used to reduce insurance premiums, among other benefits.

Conventional health insurance plans require premium payments, often in the form of monthly payments, from subscribers. In return, providers of conventional health insurance plans will insure the costs for most or all of the medical treatment services required or received by the subscribers. In conventional health care systems, there is currently very limited direct reward to maintain or improve one's health. An individual's insurance premiums are not based on the maintenance or improvement of the individual's health. Instead, insurance premiums are based on overall costs faced by health institutions and insurance plans.

Moreover, uninsured individuals can be a major upward driver of health care costs for the insured. Individuals with no health insurance or inadequate health insurance often receive health care only in cases of emergency, and hospitals often have difficulty collecting payment from these individuals. These unpaid costs are passed on to insurance companies and paying individuals.

According to systems and methods as described herein, the HCCS plan can introduce market motivation into an individual's management of his or her health care. More particularly, in various embodiments, individuals can be rewarded, via receipt of health care credits, for practicing healthy habits and, in general, being healthy. Further, various embodiments of the HCCS give individuals a greater ability to pay for health care services. For instance, individuals who cannot normally afford monthly health care premiums can enroll in an HCCS plan and receive health care credits that reduce their monthly health care premiums. Further, the various entities of the HCCS, directly or indirectly, via a government, profit or non-profit organizations, or other entities, can make health care credits available to low-income individuals at a discount or for free. Further, in various embodiments, the health care credits can be deducted from an account of the individual, can be transferrable to other individuals, and/or can be inherited or otherwise conveyed from other individuals.

According to implementations, the HCCS can comprise a plurality of entities such as insurance providers, account servicers, health care providers, separate entities that can provide accounts to individuals, and subscribers. The insurance providers can offer HCCS plans to which the subscribers can enroll or subscribe. In response to enrolling, the subscribers can receive health care credits in a lump payment, via periodic payments, or a combination thereof. The health care providers can provide medical care to the subscribers, which the subscribers can “pay” for using health care credits. The account services can manage associated HCCS accounts for the subscribers. According to implementations, each of the insurance providers, independent account providers, account servicers, and health care providers can comprise any and all hardware, software, and other resources needed to perform the systems and methods as discussed herein. Further, the subscribers can be provided with or otherwise access any and all hardware, software, and other resources needed to perform the systems and methods as discussed herein.

According to implementations, a “health care credit,” as used herein, can refer to an award, reward, or other type of credit provided to an individual in an attempt to reward individuals for good health, as well as to incentivize individuals to maintain and/or improve their health level. The health care credits can be used and accepted as a payment for health care services received by the individual, thus monetizing the health care credits. Further, the health care credits can be freely transferrable, sellable, conveyable, and/or the like, to other individuals, subscribers, and/or entities. Still further, the health care credits can be securitized. Moreover, the health care credits can be exchanged in a market-type environment comprising authorized agents, brokers, channels, and/or other entities or components.

According to implementations, a “health assessment,” as used herein, can refer to any type of physical or mental health examination (e.g., routine check-up, in-home visit, scheduled appointment), diagnostic examination (e.g., X-Ray, CT scan, blood pressure measurement, glucose level measurement), questionnaire participation, and/or any other type of assessment that can be used to determine any type of health matter or level associated with an individual.

Reference will now be made in detail to exemplary implementations of the disclosure, examples of which are illustrated in the accompanying drawings. Wherever convenient, the same reference names and numbers will be used throughout the drawings to refer to the same or like parts.

In the following description, reference is made to the accompanying drawings that form a part thereof, and in which is shown by way of illustration specific exemplary implementations. These implementations are described in sufficient detail to enable those skilled in the art to practice the implementations, and it is to be understood that other implementations can be used and that changes can be made without departing from the scope of this disclosure. The following description is, therefore, merely exemplary.

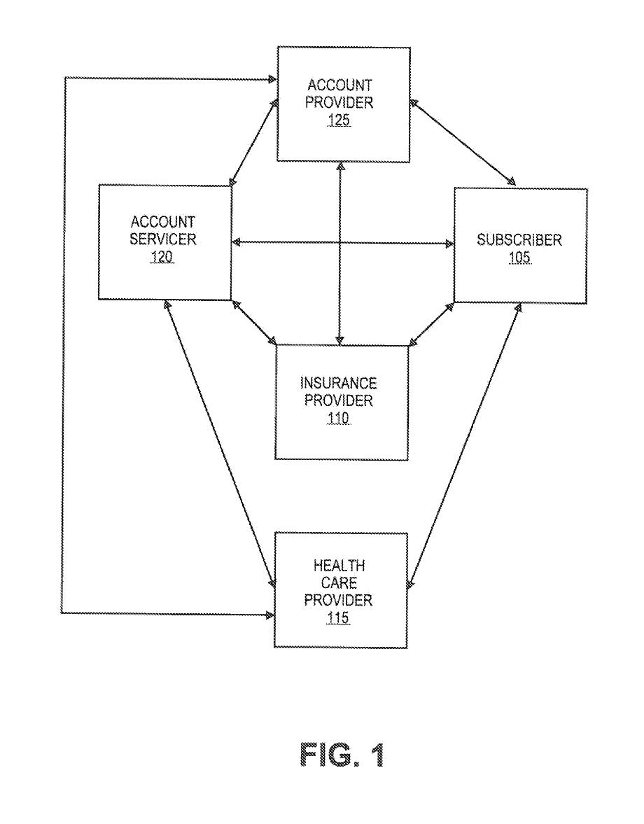

FIG. 1 illustrates a block diagram of an exemplary HCCS system 100 consistent with various implementations. As shown in FIG. 1, the system 100 can comprise a subscriber 105, an insurance provider 110, a health care provider 115, an account servicer 120, and an account provider 125. It should be appreciated that each of the components of the system 100 can comprise one or multiple entities. For example, there can be multiple subscribers 105 registered with multiple insurance providers 110. The subscriber 105 (e.g., a patient) can correspond to an individual or group of individuals who subscribe to or enroll in an insurance plan through the HCCS system 100. The insurance provider 110 can correspond to an organization or entity that can offer subscriptions to or service with an HCCS plan. In implementations, the insurance provider 110 can offer the HCCS plan as a separate insurance plan, as a supplemental component of an existing health care insurance plan, or as other offerings.

The health care provider 115 can correspond to a physician, hospital, or other individual, organization, or entity that can provide health care. Health care can comprise routine check-ups, in-home visits, scheduled appointments, emergency room care, hospital stays, and/or any other type of health care service. In various implementations, the health care provider 115 can register with the insurance provider 110 as a registered provider, or similar arrangement. For example, if the subscriber 105 is enrolled in an HCCS plan, then the subscriber 105 can query the insurance provider 110 for a list of registered health care providers, such as the health care provider 115.

The account servicer 120 can correspond to a company, organization, or other entity that can initiate and/or manage the servicing of the HCCS plans for the subscriber 105 and the insurance provider 110. In particular, the account servicer 120 can manage the distribution and exchange of health care credits resulting from the operations of the HCCS system 100. It should be appreciated that, in some implementations, the insurance provider 110, or other entities, can also serve as the account servicer 120 and perform the functions of the account servicer 120.

The account provider 125 can correspond to a company, organization, or other entity that can provide an associated account of the HCCS plan to a subscriber. In particular, the account provider 125 can maintain an account with associated health care credits for the subscriber 105. For example, a banking institution can maintain a health care credits account, in addition to a conventional bank account, for the subscriber 125. In implementations, the health care credits can be separate from those in accounts of the account servicer 120, and can be exchanged, purchased, or the like, as described herein.

According to implementations, the subscriber 105 can enroll in an HCCS plan as a new customer, or can switch into the HCCS plan from a conventional health insurance plan. Upon enrollment with the HCCS plan, the subscriber 105 can be required to pay a base premium such as, for example, $200 per month. In implementations, the base premium can be used to pay for existing benefits, or in some implementations abridged benefits, provided for by higher premium accounts in conventional insurance programs without the HCCS component. Further, the subscriber 105 can undertake a health assessment or other type of health check-up with a physician recognized by the insurance provider 110 such as, for example, the health care provider 115. It should be appreciated that other transition or initiation plans are envisioned.

The subscriber 105 can receive an initial health score that can be used to indicate a relative health level of the subscriber 105 and can be based on one or more factors and that can be used to gauge an amount of health care credits that the subscriber 105 is to receive. For example, the initial health score can be based on the health assessment taken by the subscriber 105. Further, the initial health score can be based on other factors such as, for example, age, gender, background, health history, lifestyle, and/or other factors. In some implementations, the insurance provider 110 can examine results of a health assessment taken by the subscriber 105, and compare the results to set medical guidelines or baselines to determine a health level of the individual. The health level can be relative to what can be considered a healthy person, or relative to an individual of the same age, gender, and/or the like of the subscriber 105. For example, the results of a health assessment for a 50 year-old male can be compared to health metrics of what can be considered a normal 50 year-old male, and a relative health level (e.g., excellent, good, average, poor, etc.) of the 50 year-old male can be determined based on the comparison. In other implementations, the criteria for rating the health level or the health score of the subscriber 105 can be that same or similar to that used in conventional health insurance plans to assess the health of their members. It should be appreciated that the health level and/or initial health scores associated with the subscriber 105 can be determined in any way, by any entity (e.g., the insurance provider 105, the health care provider 115, the account servicer 120, and/or others).

Once the health level and/or initial health score is determined, then the account servicer 120 or other entities can issue or provide a number of health care credits corresponding to the initial health score to the subscriber 105. For example, if the subscriber 105 is deemed to have excellent health, then the account servicer 120 can provide 7,500 health care credits to the subscriber 105; if good health, then the account servicer 120 can provide 5,000 health care credits to the subscriber 105; and if poor health, then the subscriber 105 could be awarded with zero health care credits.

The insurance provider 110 and/or the account servicer 120 can manage the subsequent issuance or distribution of additional health care credits to the subscriber 105. In particular, the subsequent distribution of health care credits can be dependent on the subscriber 105 maintaining or adhering to one or more health-related requirements or parameters specified by the HCCS plan such as, for example, avoiding the use of tobacco, controlled substances, and/or other substances, as well as exercising a certain amount of time per week, etc. Further, the subscriber 105 can be required to provide health-related information, complete periodic health exams, perform health-related tests, etc., in order to continue to receive the health care credits. For example, in some implementations, the subscriber 105 can be required to take a semi-annual health examination from the health care provider 115 that can be recognized by the insurance provider 110 and/or the account servicer 120. In some implementations, the amount of health care credits awarded to the subscriber 105 can increase, decrease, or remain the same, depending on the results of the periodic health exams. For example, if the health of the subscriber 105 improves from a previous health exam, then the subscriber 105 can be awarded with more health care credits than he or she previously received. For further example, if the health of the subscriber 105 worsens compared to a previous health exam, then the subscriber 105 can be awarded with fewer health care credits than he or she previously received. Still further, if the subscriber 105 either eliminates or starts a behavior known or suspected to improve or degrade health, such as diet, exercise, and/or the like, then the amount of health care credits awarded to the subscriber 105 can be adjusted accordingly. Therefore, the HCCS system 100 provides a direct incentive for the subscriber 105 to either maintain or improve health, and provides a disincentive to engage in behaviors or activities that may diminish health. Further, the HCCS can provide for drug and treatment interventions for the subscriber 105. For example, a physician can prescribe a medication to the subscriber 105, and a result of the intervention, such as an improvement in a medical condition, a maintaining of a current level of health, or a decline in a medical condition, can be later gathered and used for information purposes, to award credits, and for other results.

In implementations, in assessing the relative health level of the subscribers 105, the account servicer 120 can use various criteria that are used by the insurance provider 110 in existing conventional health insurance plans. Thus, the HCCS system 100 would not necessarily require adjustments or modifications to currently employed health assessments and/or medical services provisions. In some implementations, the insurance provider 110 and/or other entities can provide at-home monitoring and tracking software, products, or other resources to the subscribers 105, such that the subscribers 105 can have an active role in awareness and management of healthy behavior. For example, the at-home monitoring and tracking resources can comprise devices or components with the abilities to measure and/or record blood pressure, body weight, body mass index, heart rate, respiratory rate, running and walking times, or other metrics, either on-person or incorporated into workout devices or machines. Further, the monitoring and tracking resources can be incorporated into exercise facilities such as health clubs and gyms, and can provide a way for the subscribers 105 to be rewarded, via health care credits, for activities and efforts that enhance and maintain health. The monitoring and tracking resources can be configured to provide results of any tests or other monitored data to the insurance provider 110, account servicer 120, and/or other entities via any type of data communication channel or network. In implementations, devices and/or applications can be used to track or record exercise sessions or other forms of activity, to be used in the determination of health care credit awards. For example, smartphone applications such as step trackers or counters can tally a number of steps that an individual takes during a routine or exercise. Further, the applications can transmit exercise or activity data to the insurance provider 110, account servicer 120, and/or other entities.

In implementations, social media such as, for example, Facebook®, Twitter®, Foursquare®, Pinterest®, and other social media networks, can be used as a vehicle for managing the awarding, distribution, and/or exchange of health care credits. For example, an individual of a social networking site can motivate his or her “connections” to go to the gym, go for a run, and/or participate in other activities, and that individual can be awarded with health care credits based on the number of connections who participate in the activity. For further example, a workout facility can award health care credits to any individual who “checks-in” or otherwise indicates that he or she is present at the workout facility. It should be appreciated that other motivation and awarding techniques in the social media space are envisioned.

According to implementations, the health credits can be valued as actual currency such as, for example, United States dollars, or other currencies. For example, one (1) health care credit can be valued at 0.50 cents, one dollar, or other amounts. For further example, the health care credits can be securitized and actively bought, sold, traded, or exchanged in markets, wherein the markets themselves can dictate the value of the health care credits. In implementations, the account servicer 120 or other entities can provide each of the subscribers 105 with an associated account to which the health care credits can be deposited, transacted, or otherwise managed. In various implementations, the subscriber 105 can access the account via a website, telephone call, and/or other channels. The subscriber 105 can sell, use, transfer, redeem, or otherwise access the health care credits of the account. For example, the subscriber 205 can use the health care credits to pay for all or part of a health insurance premium; exchange the health care credits for health club memberships, discounted or free prescriptions, travel vouchers, shopping vouchers, or other goods and services; sell the health care credits to a broker or other entity; and/or donate or otherwise transfer the health care credits to an individual such as, for example, a relative; and/or use the credits to pay for another individual's treatment, health assessment, medications, and/or the like. In implementations, an account can be created or initiated for a family or other type of group, in which individuals can earn health care credits for or transfer health care credits to other individuals in the group. For example, a child can earn health care credits, and then transfer those health care credits to a parent or sibling for use by the parent or sibling. It should be appreciated that other uses of the health care credits are envisioned.

In implementations, the insurance provider 110, the account provider 125, and/or other entities can use the health care credits as an incentive to attract and/or maintain customers. For example, the insurance provider 110 can value health care credits of a subscriber at a price above what the health care credits are valued at on an exchange market. Therefore, if the subscriber of the insurance provider 110 stays with the insurance provider 110, then the subscriber's health care credits are worth more. For further example, a bank maintaining a health care credits account for a subscriber can allow the subscriber to exchange (e.g., purchase or sell) health care credits to other people or entities without having to pay an associated broker fee. It should be appreciated that other incentive techniques for maintaining and attracting customers are envisioned.

In further implementations, the insurance provider 110, the account provider 125, and/or other entities can use the health care credits to reward subscribers or individuals for maintaining or renewing relationships, subscriptions, and/or services. For example, the insurance provider 110 can institute a rewards program whereby the subscriber 105 can be awarded a set number of health care credits on a periodic basis for maintaining an insurance plan with the insurance provider 110. Further, for example, a third party entity, such as a health club, can award an individual with health care credits for initiating or renewing a membership to the health club. It should be envisioned that other loyalty awards programs, or similar programs, are envisioned.

In implementations, the HCCS system 100 can be used in conjunction with a conventional health insurance system. In some embodiments, the subscriber 105 can pay a reduced monthly premium compared to premiums required by convention insurance plans and receive reduced benefits that are supplemented by expending earned health care credits. For example, assume that a subscriber 105 of the HCCS system 100, who pays a low monthly premium, requires surgery. In contrast to a conventional health insurance plan, in which the high-premium insurance would likely cover all or more of the costs associated with the surgical procedure, the HCCS system plan might use insurance to pay a reduced percentage (e.g. 25% or other percentages) of the costs, in accordance with the reduced monthly premiums. However, the subscriber 105 would be able to use remainder of the costs not covered by the insurance with health care credits currently held in the account of the subscriber 105. If the subscriber 105 does not have enough health care credits to cover the remainder, then the subscriber 105 can use a cash payment to cover the difference, or can purchase additional health care credits from a broker, other subscriber, or other entity, or receive additional credits via other channels, such as by gift, donation, or borrowing the additional credits. For example, if a broker offers health care credits at $0.50 cents/each, and the remainder of a medical bill requires 2,000 health care credits in payment, then the subscriber 105 can purchase the 2,000 health care credits from the broker for $1,000 total.

Participating health care servicers, such as the health care provider 115, can be paid by the insurance providers 110 or the subscribers 105 in a variety of ways, in various implementations. In particular, the health care provider 115 can be paid directly, as in conventional health insurance systems. For example, the health care provider 115 can submit a bill to the insurance provider 110 for a medical service rendered on the subscriber 105, and the insurance provider 110 can pay the amount required in the bill to the health care provider 115. In addition, in situations in which the subscriber 105 is not a current subscriber of a health care plan, the subscribers 105 can directly pay the health care provider 115 with health care credits. In situations in which the subscriber 105 does have a subscription, then the insurance provider 110 can pay the health care provider 115 and deduct an appropriate amount of health care credits from the account 205 of the subscriber 105. If a subscriber 105 receives Medicare or Medicaid, or otherwise does not have a subscription with a health insurance plan, then the associated account can be managed by a private or not-for-profit health care credit brokerage company, or other entities. To be a participating institution in the HCCS system 100, the health care provider 115 can be required to accept a standardized physician health assessment that serves as the basis for the awarding of health care credits to subscribers 105. Further, the health care provider 115 can be required to accept health care credits as a form of payment for medical services and products.

The insurance providers 110 can be motivated to offer an HCCS plan to enhance competitiveness in the market, as the subscribers 105 can sign up for the financial benefits of the HCCS. In particular, conventional health insurance systems are not used as frequently by, for example, young people, because young people are usually healthy or have the ability to become healthy in a relatively short amount of time. The young people pay a premium amount that is not in proportion to the amount of health care that the young people typically receive. With the HCCS plan, young people would be motivated to enroll early to begin accruing health care credits over time. In this way, if or when using the health care credits becomes necessary, the individuals can have existing health care credits in an account to apply to any associated bills or charges. Further, the costs of the claims should be reduced over time as a result of financially-incentivized maintenance and attainment of better health by the subscribers 105. Still further, because the maintenance and attainment of better health can reduce the onset of chronic conditions and the amount of expensive procedures that are required, the HCCS can provide Medicare, Medicaid, and insurance plans with an efficient way to become more profitable.

In implementations, physicians, such as physicians associated with the health care provider 115, can also be awarded with and incentivized by the HCCS system 100. In particular, the physicians can be awarded with health care credits for keeping their patients healthy, improving the health of their patients, or other metrics. For example, a physician can be awarded with health care credits for treating a diabetic patient who has a stable and normal weight, and stable and healthy glycosylated hemoglobin levels, or other appropriate assessment parameters, as the patient can only achieve these levels if he or she is a consistent user of medication and adheres to an appropriate diet or exercise regimen. The physician can also receive additional health care credits for maintaining the patient at those levels, or improving those levels, over time. In addition, the insurance provider 110 can have an incentive to award health care credits to the physicians because healthy patients would be less likely to suffer from conditions that necessitate medical treatment, and, in particular, expensive health care such as hospitalization. Furthermore, a significant number of patients with medical conditions would be less likely to become chronically ill, and because chronic illness is a big factor of health insurance costs, the costs can be reduced as a result of the HCCS. Foundations such as Medicare and Medicaid, as well as the insurance providers 110, can award health care credits to the physicians based on patient-health metrics. In turn, the physicians can use the health care credits themselves, sell or transfer the health care credits, or provide the health care credits to their patients as, for example, health achievement bonuses.

Similarly, employers of the patients can also be incentivized to participate in HCCS plans, and further to award health care credits, because healthier employees can result in reduced insurance premium payments for the employers, as well as an increase in employee productivity. In addition, the employers can implement various incentive plans for employees. For example, an employer can award an employee with a compensation raise if the employee meets or exceeds a health goal. For further example, the employer can institute a matching plan to match a percentage of their employees' earned health care credits. Further, for example, the employers themselves can outright award credits to the employees.

In addition, governments can be incentivized to participate in HCCS plans, and further to award health care credits to individuals who are on public assistance, because healthier individuals can lead to reduced medical costs paid by the government. Still further, individuals on public assistance who are enrolled in HCCS plans can have an incentive to accumulate health care credits for preventative care (e.g., vaccinations, baby care, etc.), as well as to use the health care credits to purchase health-related or non-health-related goods and services. The HCSS plan can further offer a convenient way for uninsured citizens or individuals on public assistance to gain access to a payment method for health care services via purchasing health care credits or receiving health care credits via philanthropy or other causes.

Moreover, pharmaceutical and medical technology companies can have an incentive to participate in HCCS plans because a larger number of patients will be able to gain access to medicines, procedures, and other resources when the patients need them. Furthermore, health care plans can award health care credits to pharmaceutical and medical technology companies if associated drugs and devices contribute to health improvements in individuals.

In implementations, the insurance provider 110, account servicer 120, account provider 125, and/or other entities can gather information associated with multiple HCCS accounts, and can use the information in various ways such as, for example, as a basis for derivative securities. For example, the information can be sold to a third party entity which can use the information for various services. It should be appreciated that other uses of the information associated with the HCCS plans by any of the associated entities are envisioned.

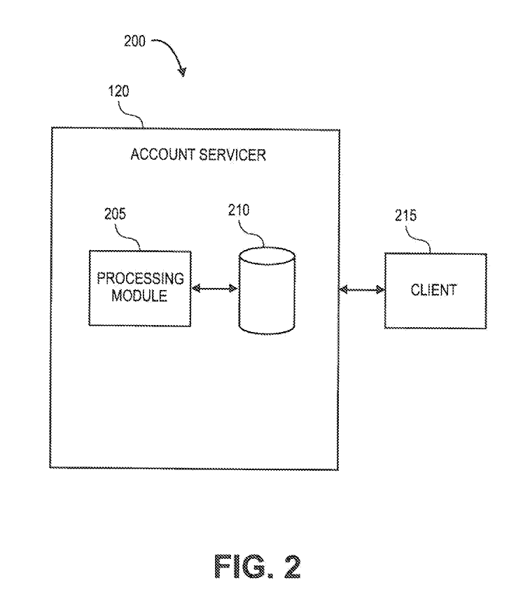

FIG. 2 illustrates an exemplary environment 200 consistent with various implementations. In particular, the environment 200 comprises the account servicer 120 that can be interfaced with a client 215. It should be appreciated that, while FIG. 2 depicts resources of the account servicer 120, the resources and associated functionalities can be applied across any and all of the resources of the HCCS system 100, such as the insurance provider 110, health care provider 115, and subscriber 105.

According to implementations, the account servicer 120 can comprise a processing module 205 and a database 210. The processing module 205 can be any combination of hardware and/or software resources that are capable of executing applications or processes to manage and/or maintain the functionalities of the HCCS system 100, as discussed herein. Further, the database 210 can be configured to store any type of data that can be used with the HCCS system 100. For example, the data associated with accounts of the subscribers 105 can be stored in the database 210.

In implementations, the processing module 205 can be configured to receive, access, output, and/or process data associated with the functionalities of the HCCS system 100. For example, the processing module 205 can receive an indication of an enrollment of a subscriber, receive an indication of an amount of health care credits issued to a subscriber, process a payment of a medical procedure statement, and perform other functions. Further, the processing module 205 can be configured to provide any data to the database 210 for storage and access availability. For example, if a subscriber pays for a medical procedure using health care credits, then the processing module 205 can provide associated data to the database 210.

Referring to FIG. 2, the environment 200 can further comprise a client 215 that can be configured to connect to the account servicer 120 and components thereof. The client 215 can be accessed or utilized by a user, administrator, owner, subscriber, or other individual or entity. Further, the account servicer 120, or components thereof, can provide data to the client 215 for, for example, reference or reporting purposes. In particular, an administrator can use the client 215 to request data processed by the processing module 205, and the processing module 205 can identify, locate, and provide the appropriate data to the client 215. Further, the processing module 205 can process data such that the data is displayed in a report, chart, graph, or other type of representation, and provide the processed data to the client 215.

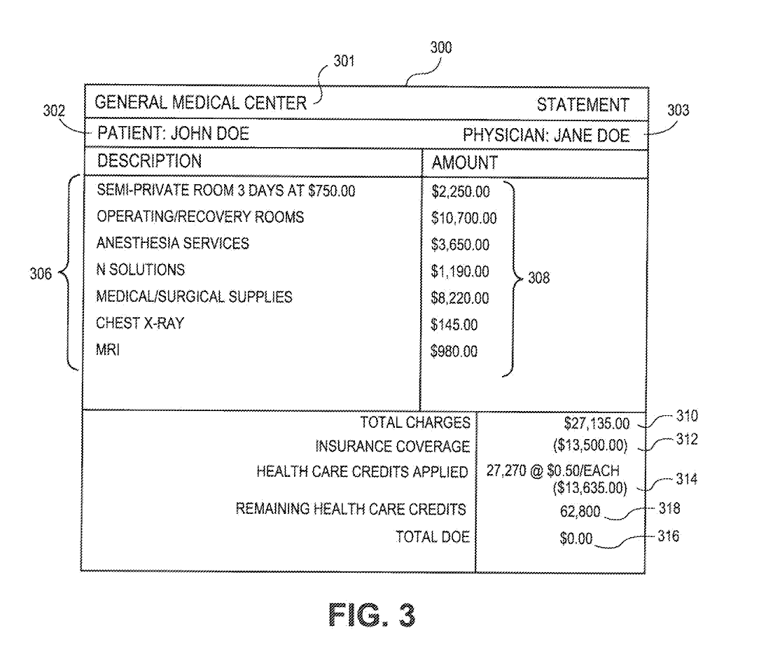

Referring to FIG. 3, depicted is an exemplary statement 300 that can detail medical treatment received by an individual, such as the subscriber 105. It should be appreciated that the information and data contained in the statement 300 is merely exemplary, and that statement 300 can comprise other data in various formats without departing from the principles of the invention.

As shown in FIG. 3, the statement 300 comprises identifying information, such as a hospital name 301, a patient name 302, and a physician name 303. More particularly, in the example depicted in FIG. 3, John Doe received treatment from Jane Doe at General Medical Center. The statement 300 further comprises indications 306 of treatments or services administered to, or resources consumed by the patient. For example, John Doe had a semi-private hospital room for three days at a rate of $750.00 per day. Further, John Doe had IV solutions administered to him. The statement 300 further comprises prices, costs, or fees 308 associated with the treatments, services, and/or resources 306. For example, the chest x-ray administered to John Doe cost $145.00, and the anesthesia services cost $3,650.00.

Further, the statement 300 comprises a total charge amount 310 as well as an insurance coverage amount 312. In particular, the total charge amount 310 represents a sum of all of the fees 308 and the insurance coverage amount 312 corresponds to the amount that an insurance provider, such as the insurance provider 110, pays towards the total charge amount 310.

The statement 300 further comprises an amount of health care credits 314 applied to the total charge amount 310. In particular, the health care credits can be valued at a fixed price, at a market price, or according to another valuing mechanism. As shown in FIG. 3, the value of a single health care credit is $0.50, meaning that 27,270 health care credits are valued at $13,635. After the 27,270 health care credits 314 are applied to the total charge amount 310, a total due amount 316 can indicate the remaining amount due.

In implementations, the statement 300 can comprise an indication of a remaining health care credits 318. In particular, the remaining health care credits 318 can indicate the amount of health care credits that the patient has in his or her associated HCCS account. The amount of remaining health care credits 318 can be obtained from or by any entity of the HCCS system 100. For example, the insurance provider 110 can retrieve the amount of remaining health care credits 318 from the account servicer 120. Further, the amount of remaining health care credits 318 can dynamically update based on the amount of health care credits 314 applied.

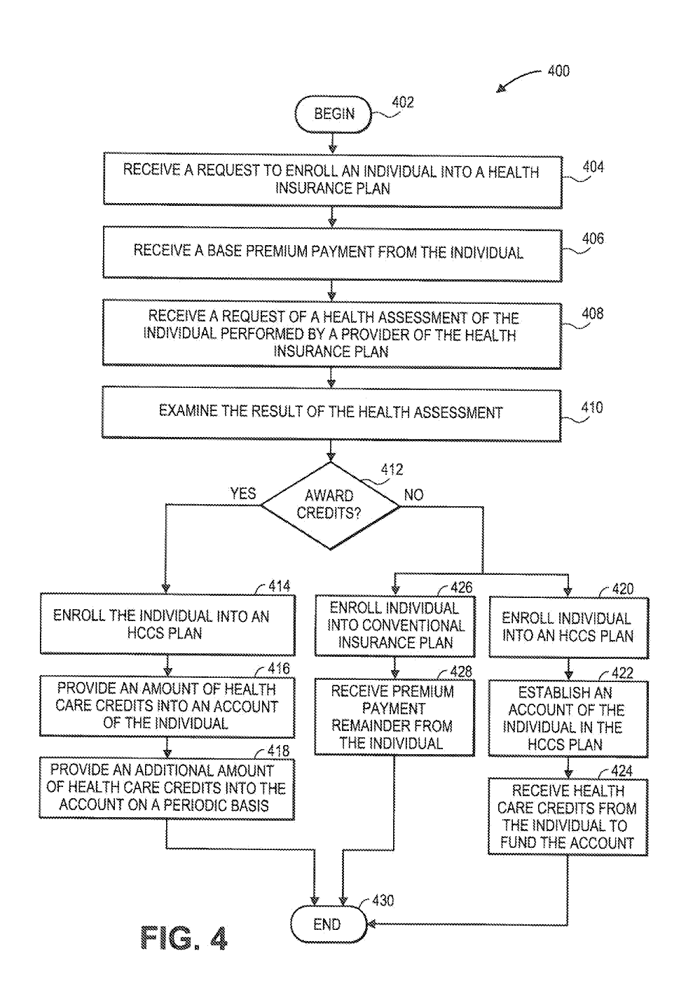

FIG. 4 is a flow diagram illustrating an exemplary process 400 for enrolling an individual into a health insurance plan, such as an HCCS plan or a conventional insurance plan having an HCCS component. In implementations, the process 400 can be performed by an insurance provider, such as the insurance provider 110, or by any other entity or logic in a system. It should be apparent to those of ordinary skill in the art that the diagram depicted in FIG. 4 represents a generalized illustration and that other processing may be added or existing processing can be removed or modified without departing from the principles of the invention.

The process 400 begins at 402. In 404, the insurance provider can receive a request to enroll an individual into a health insurance plan. The individual can have an existing insurance plan with the insurance provider, such as a conventional insurance plan, or can be a new subscriber. Further, the request can specify that the individual desires to enroll in an HCCS plan offered by the insurance provider. In 406, the insurance provider can receive a base premium payment from the individual. In some embodiments, the base premium payment can cover or pay for an abridged version of the existing benefits provided for in higher premium accounts, such as conventional insurance plans without an HCCS component. For example, while a premium payment for a conventional insurance plan may be $200/month, the base premium payment may be $75.

In 408, the insurance provider can receive a result of a health assessment of the individual performed by a physician recognized by the insurance provider. The result of the health assessment can be received directly from the physician (or associated hospital, medical care facility, or the like), or from the individual. In 410, the insurance provider can examine the result of the health assessment. In implementations, the result can indicate a general health of the individual (e.g. excellent, good, fair, poor, and/or others), and/or any conditions, injuries, or ailments that the individual has or suffers from, and/or other information or data.

In 412, the insurance provider can make a determination as to whether to award any health care credits to the individual. For example, if the individual is deemed to be in excellent health, then the insurance provider can award, to the individual, a corresponding amount of health care credits, such as a maximum amount allotted for a new subscriber. For further example, if the individual is rated as being in good health, then the insurance provider can award a lesser amount of health care credits to the individual. Further, for example, if the individual is evaluated as being in poor health, then the insurance provider can enroll the individual in an HCCS plan, but can award the individual with a minimal amount of health care credits, or zero credits. In implementations, the insurance provider can deem an individual having poor health as ineligible for enrollment into the HCCS component of the health insurance plan. It should be appreciated that other health credit award techniques and conventions are envisioned.

If the insurance provider awards credits to the individual (412, Yes), then processing can proceed to 414 in which the insurance provider can enroll the individual into an HCCS plan, such as an HCCS component of an existing health insurance plan. In embodiments, if the individual has an existing health insurance plan, then the enrollment into an HCCS component of the insurance plan can lower the premium payment associated with the insurance plan. The health care credits associated with the HCCS plan can be managed in an account for the individual provided by the insurance provider 110 or by a third party, such as the account servicer 120. In 416, the insurance provider 110 can provide the amount of health care credits into an account of the individual. In particular, as noted above, the amount of health care credits can be determined based on the result of the health assessment. Further, the account of the individual, as managed by the insurance provider or the third party account servicer, can reflect with the amount of health care credits. In embodiments, the insurance provider can issue a limited insurance plan to the individual to be used to insure a portion of the individual's health care services, as well as to be used in combination with the awarded health care credits. In 418, the insurance provider can provide an additional amount of health care credits into the account, for example on a periodic or event-driven basis. For example, the individual can receive subsequent health assessment(s), and, based on the results of the subsequent health assessment(s), can be awarded with the additional health care credits.

Referring again to 412, if the insurance provider does not award credits to the individual (412, No), then processing can proceed to either 420 or 426, which can depend on the desires of the individual. If the individual desires to enroll in an HCCS plan without an initial amount of credits, then processing can proceed to 420, in which the insurance provider can enroll the individual into the HCCS plan, such as an HCCS component of an existing health insurance plan. In implementations, the insurance provider can charge the subscriber a fee to enroll in the plan. In 422, the insurance provider, or a third party entity such as an account servicer 120, can establish an account of the individual in the HCCS plan. In 424, the insurance provider 110 or the account servicer 120 can optionally receive health care credits from the individual to fund the account. For example, the account can be funded with health care credits that can be purchased from a broker or other entity, transferred from another individual, and/or received via another channel or outlet. In implementations, if the health of the individual improves, as deemed by a subsequent health examination, then the insurance provider 110 can provide the individual with health care credits awards, consistent with improvements in existing terms or conditions, or other factors.

If the individual desires to enroll in a conventional insurance plan, the processing can proceed to 426 in which the insurance provider can enroll the individual into the conventional insurance plan. In some cases, the enrollment may be unnecessary if the individual is already enrolled in a conventional insurance plan. In 428, the insurance provider can receive a remainder of the premium payment from the individual. In particular, the remainder can correspond to the difference between the premium payment for the conventional insurance plan and the base premium payment already received from the individual. It should be appreciated that the individual can, at any time, switch enrollment from a conventional insurance plan to an HCCS plan, and vice-versa. In 430, the processing can end, repeat, or return to any of the previous steps.

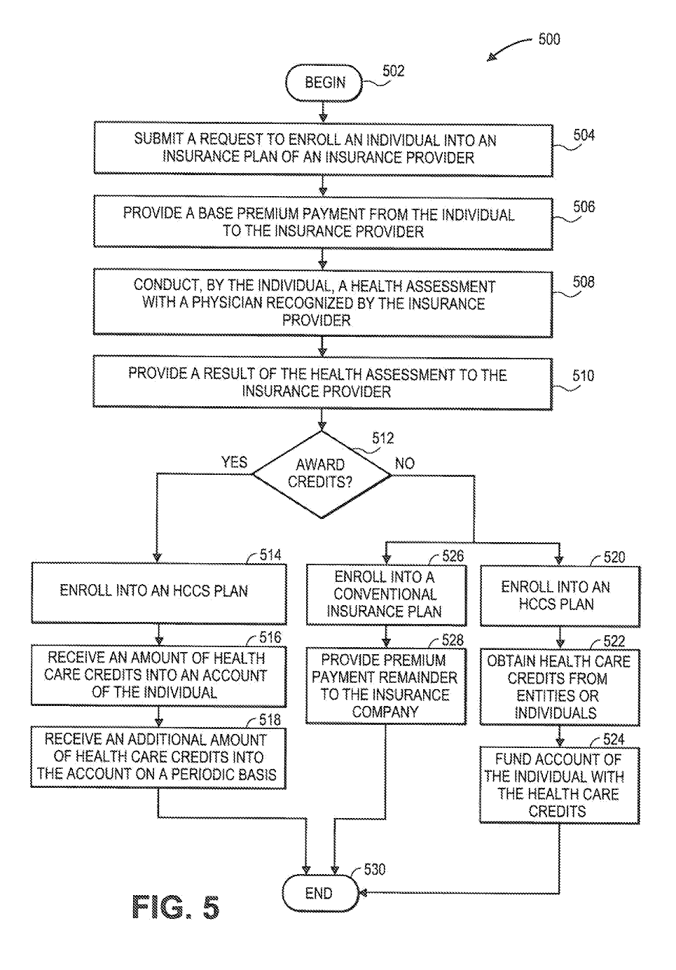

FIG. 5 is a flow diagram illustrating an exemplary process 500 for enrolling an individual into a health insurance plan, such as an HCCS plan or a conventional insurance plan having an HCCS component. In implementations, the process 500 can be performed by an individual, such as the subscriber 105, any logic or components associated with the individual, or by any other entity or logic in a system. It should be apparent to those of ordinary skill in the art that the diagram depicted in FIG. 5 represents a generalized illustration and that other processing may be added or existing processing can be removed or modified without departing from the principles of the invention.

The process 500 begins at 502. In 504, the individual can submit a request for enrollment into an insurance plan of an insurance provider. The individual can have an existing insurance plan with the insurance provider, such as a conventional insurance plan, or can be a new subscriber. In 506, the individual can provide a base premium payment to the insurance provider. In various embodiments, the base premium can cover or pay for an abridged version of the existing benefits provided for in higher premium accounts, such as conventional insurance plans without an HCCS component. For example, while a premium payment for a conventional insurance plan may be $200/month, the base premium payment may be $125.

In 508, the individual can conduct a health assessment with a physician recognized by the insurance provider. In 510, the individual can provide a result of the health assessment to the insurance provider. In some cases, the physician (or associated hospital, medical care facility, or the like) can provide the result of the health assessment to the insurance provider. In implementations, the result can indicate a general health of the individual (e.g., via a rating, such as excellent, good, fair, poor, and/or others), any conditions, injuries, or ailments that the individual has or suffers from, and/or other information or data.

In 512, a determination can be made whether to award the individual with health care credits. In particular, the insurance provider can examine the result of the health assessment and can make a determination as to whether to award any health care credits to the individual. For example, if the individual is deemed to be in excellent health, then the insurance provider can award, to the individual, a corresponding amount of health care credits, such as a maximum amount allotted for a new subscriber. For further example, if the individual is rated as being in good health, then the insurance provider can award a lesser amount of health care credits to the individual. Further, for example, if the individual is evaluated as being in poor health, then the insurance provider can initially either award zero health care credits or a reduced number of health care credits. It should be appreciated that other health credit award mechanisms and conventions are envisioned.

If the insurance provider awards credits to the individual (512, Yes), then processing can proceed to 514 in which the individual can enroll into an HCCS plan, such as an HCCS component of an existing health insurance plan. In embodiments, if the individual has an existing health insurance plan, then the enrollment into an HCCS component of the insurance plan can lower the premium payment associated with the insurance plan. The health care credits associated with the HCCS plan can be managed in an account for the individual provided by the insurance provider 110 or by a third party, such as the account servicer 120. In 516, the individual can receive an amount of health care credits into the account of the individual. In particular, as noted above, the amount of health care credits can be determined based on the result of the health assessment, and the account of the individual, as managed by the insurance provider or the third party account servicer, can reflect with the amount of health care credits. In embodiments, the insurance provider can issue a limited insurance plan to the individual to be used to insure a portion of the individual's health care services, as well as to be used in combination with the awarded health care credits. In 518, the individual can receive an additional amount of health care credits into the account, for example on a periodic or event-driven basis. For example, the individual can receive health checkups, and, based on the results of the health checkups, can be awarded with the additional health care credits.

Referring again to 512, if the insurance provider does not award credits to the individual (512, No), then processing can proceed to either 520 or 526, which can depend on the desires of the individual. If the individual desires to enroll in an HCCS plan without an initial amount of credits, then processing can proceed to 520, in which the individual can enroll into an HCCS plan, such as an HCCS component of an existing health insurance plan. In 522, the individual can obtain health care credits from entities or individuals. In particular, the health care credits can be purchased from a broker or other entity, transferred from another individual, and/or received via another outlet. In 524, the individual can fund an associated account with the obtained health care credits. The associated account can be funded by providing the health care credits to the insurance provider 110 or a third party entity such as an account servicer 120. In implementations, if the health of the individual improves, as deemed by a subsequent health examination, then the individual can receive health care credits awards from the insurance provider 110, consistent with improvements in existing terms or conditions, or other factors.

If the individual desires to enroll in a conventional insurance plan, the processing can proceed to 526 in which the individual can enroll into a conventional insurance plan. In some cases, the enrollment may be unnecessary if the individual is already enrolled in a conventional insurance plan. In 528, the individual can provide a remainder of the premium payment to the insurance provider. In particular, the remainder can correspond to the difference between the premium payment for the conventional insurance plan and the base premium payment already provided to the insurance provider. It should be appreciated that the individual can, at any time, switch enrollment from a conventional insurance plan to an HCCS plan, and vice-versa. In 530, the processing can end, repeat, or return to any of the previous steps.

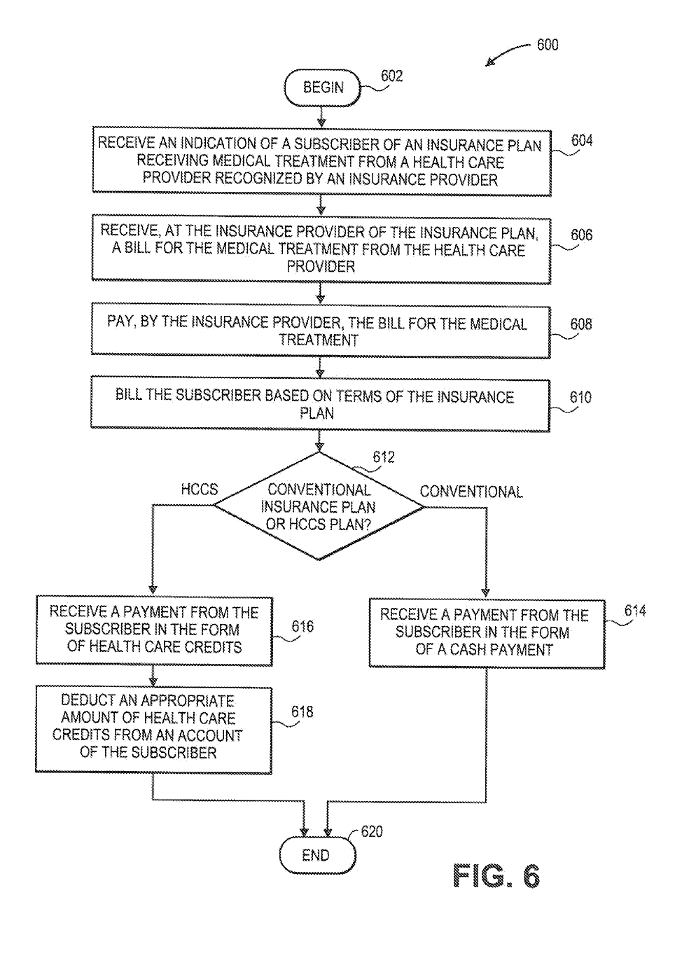

FIG. 6 is a flow diagram illustrating an exemplary process 600 for redeeming health care credits as payment for health care services associated with an HCCS plan. In implementations, the process 600 can be performed by an insurance provider, such as the insurance provider 110, or by any other entity or logic in a system. It should be apparent to those of ordinary skill in the art that the diagram depicted in FIG. 6 represents a generalized illustration and that other processing may be added or existing processing can be removed or modified without departing from the principles of the invention.

The process 600 begins at 602. In 604, the insurance provider can receive an indication of a subscriber of an insurance plan receiving medical treatment from a health care provider recognized by the insurance provider. The medical treatment can be any type of treatment such as, for example, routine check-ups, in-home visits, scheduled appointments, emergency room care, hospital stays, and/or any other type of health care. In 606, the insurance provider can receive, from the health care provider, a bill for the medical treatment. In implementations, the bill itself can provide the indication of the subscriber receiving the medical treatment. In 608, the insurance provider can pay the bill for the medical treatment. In some cases, the insurance provider can pay part of the bill or the entire bill.

In 610, the insurance provider can bill the subscriber based on terms of the insurance plan. For instance, the terms of the insurance plan can indicate that the subscriber should be billed based on a standard deductible, co-insurance, and/or other policy features. In 612, the insurance provider can identify the type of insurance plan held by the subscriber, namely, a conventional insurance plan or an HCCS plan. If the subscriber has a conventional insurance plan (612, Conventional), the processing can proceed to 614 in which the insurance provider can receive a payment from the subscriber in the form of a cash payment. In contrast, if the subscriber has an HCCS plan (612, HCCS), then processing can proceed to 616 in which the insurance provider can receive a payment from the subscriber, wherein the payment is in the form of health care credits. More particularly, to account for any part of the bill that is not covered by the insurance portion of the HCCS plan, the subscriber can have health care credits from his/her account transferred to the insurance provider or otherwise applied to this part of the bill. In 618, the insurance provider or another entity such as the account servicer 120 can deduct an appropriate amount of health care credits from the account of the subscriber. It should be appreciated that the subscriber can use other forms of payment to account for any remainder of the bill for the medical treatment. In 620, the processing can end, repeat, or return to any of the previous steps.

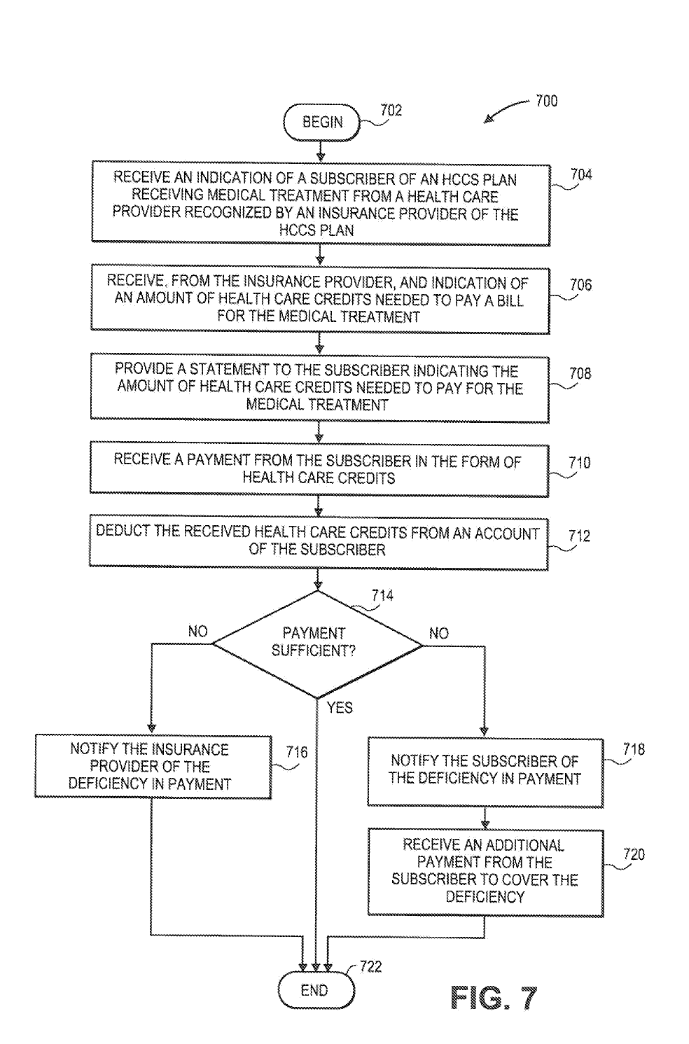

FIG. 7 is a flow diagram illustrating an exemplary process 700 for processing a medical bill with health care credits associated with an HCCS plan. In implementations, the process 700 can be performed by an account servicer, such as the account servicer 120, or by any other entity or logic in a system. It should be apparent to those of ordinary skill in the art that the diagram depicted in FIG. 7 represents a generalized illustration and that other processing may be added or existing processing can be removed or modified without departing from the scope of the invention.

The process 700 begins at 702. In 704, the account servicer can receive an indication of a subscriber of an HCCS plan receiving medical treatment from a health care provider recognized by an insurance provider. The indication can comprise a bill associated with the medical treatment. The medical treatment can be any type of treatment such as, for example, routine check-ups, in-home visits, scheduled appointments, emergency room care, hospital stays, and/or any other type of health care. In 706, the account servicer can receive, from the insurance provider, physician, or associated health care center, an indication of an amount of health care credits needed to pay the bill for the medical treatment.

In 708, the account servicer can provide a statement to the subscriber indicating the amount of health care credits needed to pay the bill for the medical treatment. In particular, the amount of health credits needed can correspond to a remainder of the bill that was not covered by any insurance associated with the HCCS plan. In 710, the account servicer can receive a payment from the subscriber in the form of health care credits. In some cases, the subscriber can indicate how many health care credits he or she wishes to apply to the statement. In 712, the account servicer can deduct the health care credits that were received in the payment from an account of the subscriber.

In 714, the account servicer can determine if the payment received from the subscriber is sufficient to satisfy the statement. If the payment is sufficient (714, Yes), then processing can proceed to 722 in which processing can end, repeat, or return to any of the previous steps. In implementations, the account servicer can notify the subscriber, the insurance provider, and/or other entities of the satisfied payment. In contrast, if the payment is not sufficient (714, No), then the account servicer can perform one or more options. In one option, in 716, the account servicer can notify the insurance provider of the deficiency in the payment. The insurance provider can then bill the subscriber directly or perform other payment remedying techniques. In another option, in 718, the account servicer can notify the subscriber of the deficiency in payment. In implementations, the subscriber can obtain, via purchasing or other channels, enough health care credits to cover the deficiency. In 720, the account servicer can receive an additional payment from the subscriber to cover the deficiency. In some cases, the additional payment can be in the form of health care credits, cash, or a combination thereof. In 722, processing can end, repeat, or return to any of the previous steps.

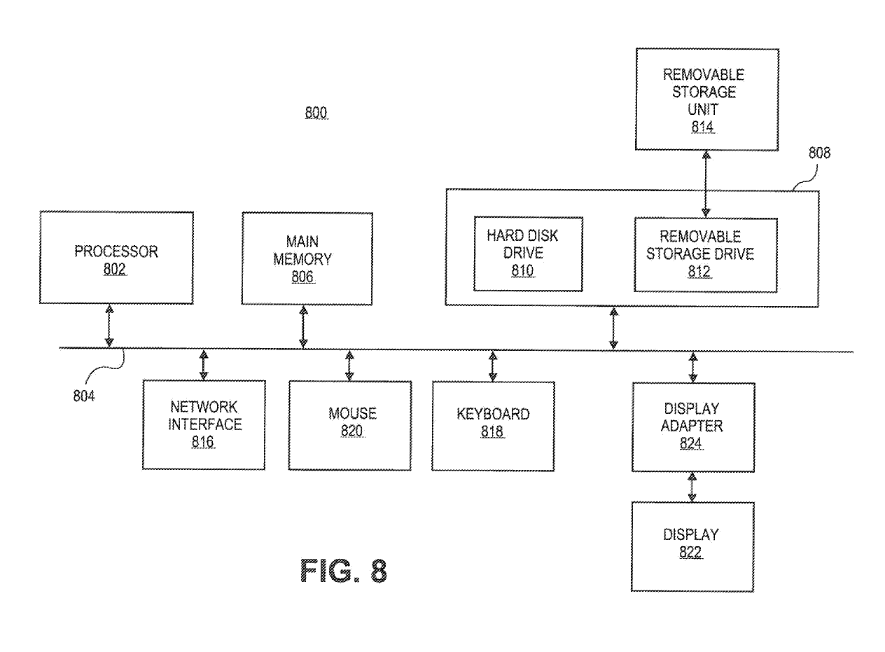

FIG. 8 illustrates an exemplary block diagram of a computing system 800 which can be implemented to store and execute processing modules associated with components of the HCCS system 100, according to various implementations. In embodiments, the processing modules can be stored and executed on the computing system 800 in order to implement the systems, processes, and methods as described herein. The computing systems 800 can represent an example of any computing systems in the HCCS system 100. While FIG. 8 illustrates various components of the computing system 800, one skilled in the art will realize that existing components can be removed or additional components can be added without departing from the principles of the invention.

As shown in FIG. 8, the computing system 800 can comprise one or more processors, such as a processor 802 that provide an execution platform for embodiments of the processing modules. Commands and data from the processor 802 can be communicated over a communication bus 804. The computing system 800 can also comprise a main memory 806, for example, one or more computer readable storage media such as a Random Access Memory (RAM), where the processing modules and other application programs, such as an operating system (OS) can be executed during runtime, and can comprise a secondary memory 808. The secondary memory 808 can comprise, for example, one or more computer readable storage media or devices such as a hard disk drive 810 and/or a removable storage drive 812, representing a floppy diskette drive, a magnetic tape drive, a compact disk drive, etc., where a copy of an application program embodiment for the processing modules can be stored. The removable storage drive 812 reads from and/or writes to a removable storage unit 814 in a well-known manner. The computing system 800 can also comprise a network interface 816 in order to connect with any type of network, whether wired or wireless.

In embodiments, a user can interface with the computing system 800 and operate the processing modules with a keyboard 818, a mouse 820, and/or a display 822. To provide information from the computing system 800 and data from the processing modules, the computing system 800 can comprise a display adapter 824. The display adapter 824 can interface with the communication bus 804 and the display 822. The display adapter 824 can receive display data from the processor 802 and convert the display data into display commands for the display 822.

The foregoing description is illustrative, and variations in configuration and implementation may occur to persons skilled in the art. For instance, the various illustrative logics, logical blocks, modules, and circuits described in connection with the implementations disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more exemplary implementations, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the elements described herein can also be included within the scope of computer-readable media.

The processing of a method or algorithm described in connection with the implementations disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium is coupled to the processor, such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

What is claimed is:

1. A method of encouraging healthy behavior by an individual, comprising:
determining a health level of the individual;
calculating, using a computing system, an amount of health care credits to award to the individual based on the health level; and
providing, to the individual and using the computing system, the amount of health care credits.

2. The method of claim 1, wherein determining the health level of the individual comprises:
receiving a result of a health assessment of the individual; and
comparing the result of the health assessment to a baseline health level to determine the health level.

3. The method of claim 2, wherein the baseline health level is a set of health metrics corresponding to a healthy person.

4. The method of claim 2, wherein the baseline health level is a set of health metrics corresponding to a health level previously determined for the individual.

5. The method of claim 1, wherein providing the amount of health care credits comprises:
depositing the amount of health care credits into an account of the individual.

6. The method of claim 1, further comprising:
receiving an indication of an additional amount of health care credits acquired by the individual.

7. The method of claim 1, further comprising:
calculating an amount of a premium payment for a health insurance policy based on the amount of health care credits provided to the individual, wherein the health insurance policy is funded with a combination of the amount of the premium payment and the amount of the health care credits; and
enrolling the individual in the health insurance policy.

8. The method of claim 1, further comprising:
appending a health care credits component to an existing health insurance policy of the individual; and
reducing a premium payment associated with the existing health insurance policy in response to appending the health care credits component.

9. The method of claim 1, further comprising:
enrolling the individual in a health insurance policy in response to providing the amount of health care credits to the individual, wherein the health insurance policy provides insurance that supplements the health care credits.

10. The method of claim 1, further comprising:
determining an additional health level of the individual;
comparing the additional health level of the individual to the health level;
calculating an additional amount of health care credits to award to the individual based on the comparing; and
providing the additional amount of health care credits to the individual.

11. A system for encouraging healthy behavior by an individual, comprising:
a computer readable storage medium containing instructions; and
a processor, operably connected to the computer readable storage medium, that executes the instructions to perform operations comprising:
determining a health level of the individual;
calculating an amount of health care credits to award to the individual based on the health level; and
providing, to the individual, the amount of health care credits.

12. The system of claim 11, wherein determining the health level of the individual comprises:
receiving a result of a health assessment of the individual; and
comparing the result of the health assessment to a baseline health level to determine the health level.

13. The system of claim 12, wherein the baseline health level is a set of health metrics corresponding to a healthy person.

14. The system of claim 12, wherein the baseline health level is a set of health metrics corresponding to a health level previously determined for the individual.

15. The system of claim 11, wherein providing the amount of health care credits comprises:
depositing the amount of health care credits into an account of the individual.

16. The system of claim 11, wherein the processor executes the instructions to perform operations further comprising:
receiving an indication of an additional amount of health care credits acquired by the individual.

17. The system of claim 11, wherein the processor executes the instructions to perform operations further comprising:
calculating an amount of a premium payment for a health insurance policy based on the amount of health care credits provided to the individual;
enrolling the individual in the health insurance policy in exchange for receiving the amount of the premium payment.

18. The system of claim 11, wherein the processor executes the instructions to perform operations further comprising:
determining an additional health level of the individual;
comparing the additional health level of the individual to the health level;
calculating an additional amount of health care credits to award to the individual based on the comparing; and
providing the additional amount of health care credits to the individual.

19. A method of encouraging healthy behavior, comprising:
examining, by a computing system, a result of a health assessment of an individual to determine a health level of the individual;
calculating, by the computing system, an amount of health care credits to award to the individual based on the health level of the individual; and
providing the amount of health care credits into an account of the individual.

20. The method of claim 19, further comprising:
examining a result of an additional health assessment of the individual subsequent to the health assessment to determine a subsequent health level of the individual relative to the health level;
calculating an additional amount of health care credits to award to the individual based on the subsequent health level; and
providing the additional amount of health care credits into the account.

21. The method of claim 19, further comprising:
enrolling the individual into a health insurance policy associated with the health care credits.

22. The method of claim 19, wherein examining the result of the health assessment comprises:
comparing the result of the health assessment to a set of baseline metrics.

23. The method of claim 22, wherein the set of baseline metrics corresponds to that of a healthy person.

24. The method of claim 22, wherein the set of baseline metrics corresponds to that of a person having the same age and gender as the individual.

25. The method of claim 19, further comprising:
receiving an indication of an additional amount of health care credits acquired by the individual; and
providing the additional amount of health care credits into the account of the individual.
